(19) United States
(12) Patent Application Publication
(10) Pub. No.: US 2011/0130142 A1
(43) Pub. Date: Jun. 2, 2011

(54) FEMTOCELL, BASE STATION, FEMTO GATEWAY, AND COMMUNICATION METHOD THEREOF

(75) Inventors: Heng-Iang HSU, Taipei City (TW); Hsien-Tsung HSU, Taipei City (TW); Jean-Chian CHIOU, Yonghe City (TW); I-Hung LIN, Taipei City (TW)

(73) Assignee: INSTITUTE FOR INFORMATION INDUSTRY, Taipei (TW)

(21) Appl. No.: 12/629,872

(22) Filed: Dec. 2, 2009

(30) Foreign Application Priority Data
Nov. 27, 2009 (TW) 098140564

(51) Int. Cl. H04W 4/00; H04W 52/02; H04W 92/00; H04W 36/00

(52) U.S. Cl. 455/436; 455/522; 455/63.1; 455/561

(57) ABSTRACT

A femtocell, a base station, a femto gateway, and communication methods thereof are provided. The femtocell is connected to the femto gateway via the base station. The femtocell turns off its RF transceiver when the RF transceiver is idle for a predetermined time interval. When the base station determines that a mobile station enters its signal coverage, the base station transmits a notification signal to the femto gateway. After receiving the notification signal, the femto gateway transmits a turn-on signal to the femtocell via the base station. After receiving the turn-on signal, the femtocell turns on its RF transceiver and transmits an acknowledgement signal to the femto gateway. Since the femtocell only turns on its RF transceiver when a mobile station needs its service, the femtocell consumes less power. In addition, interferences between femtocells can be reduced.

### PRIORITY

This application claims priority to Taiwan Patent Application No. 098140564 filed on Nov. 27, 2009, the disclosure of which is incorporated by reference herein in its entirety.

### FIELD

The present invention relates to a femtocell, a base station, a femto gateway, and communication methods thereof. More particularly, the femtocell, the base station, the femto gateway, and the communication methods thereof according to the present invention turns on a radio frequency (RF) transceiver of the femtocell only when use of the femtocell is necessary, thereby reducing signal interference between the femtocell and other femtocells and consuming less power of the femtocell.

### BACKGROUND

Conventionally, problems of poor signal reception, a too slow transmission rate and the like are often encountered when a wireless mobile communication network is used indoors. The main reason for poor signal quality in an indoor environment lies in that, high-frequency wireless signals tend to be attenuated rapidly when passing through the wall barriers. Although a variety of communication devices using different network interfaces (e.g., Wireless Fidelity (Wi-Fi)) and High Speed Packet Access (HSPA)) have been provided in the market to solve these problems, these communication devices increase the cost for the users.

The Femto Forum established in 2007 has proposed a Femto Access Point (FAP) to solve various problems of indoor wireless mobile communication networks completely. A FAP is an access point (AP) of a low power level that uses a licensed wireless frequency band at a front end thereof, so no changes need to be made on the user's equipment. For the operators, a larger wireless network coverage rate may be achieved in an indoor environment by use of a FAR A back end of the FAP is connected to an operator's network through an existing wired network technology (e.g., through a Digital Subscriber Line (DSL) modem or through a cable modem) to facilitate the operator to provide better network management services.

FIG. 1 depicts a conventional network system 1 that adopts a femtocell architecture. A base station 15 of the network system 1 is connected to a femto gateway 19 via the Internet 17. Femotocells 111, 113 are deployed in houses 11, 13 respectively and connected to the base station 15 respectively. Mobile devices 113, 115 in the house 11 connect to the network via the femtocell 111, and similarly, mobile devices 133, 135 in the house 13 connect to the network via the femtocell 131. However, if operating frequency bands are not allocated in an appropriate way after the femtocells have been deployed in a large amount, interference among the femtocells may degrade the overall performance of the system unexpectedly. For example, in case the houses 11, 13 are neighbors, signals transmitted by the femtocells 111, 131 would interfere with each other to cause degradation in communication quality.

Accordingly, there remains a continuing need in the art to provide improved communication quality when femtocells are deployed in a large amount.

### SUMMARY

An objective of certain embodiments of the present invention is to provide a base station. A network system comprises a femtocell, the base station, and a femto gateway. The femtocell is connected to the femto gateway via the base station. The base station comprises a processing unit and a transceiver. The processing unit is configured to determine that a mobile station enters a signal coverage of the base station. The transceiver is configured to transmit a notification signal to the femto gateway after the processing unit determines that the mobile station enters the signal coverage of the base station so that the femto gateway transmits a turn-on signal. The transceiver is further configured to relay the turn-on signal to the femtocell so that the femtocell turns on a radio frequency (RF) transceiver of the femtocell and transmits an acknowledgement (ACK) signal after receiving the turn-on signal. The transceiver is further configured to relay the ACK signal to the femto gateway.

Another objective of certain embodiments of the present invention is to provide a femto gateway. A network system comprises a femtocell, a base station, and the femto gateway. The femtocell is connected to the femto gateway via the base station. The femto gateway comprises a transceiver and a processing unit. The transceiver is configured to receive a notification signal from the base station. The processing unit is configured to choose the femtocell after the transceiver receives the notification signal. The transceiver is further configured to transmit a turn-on signal to the femtocell after the processing unit chooses the femtocell so that the femtocell turns on an RF transceiver of the femtocell and transmits an ACK signal after receiving the turn-on signal. The transceiver is further configured to receive the ACK signal transmitted by the femtocell via the base station.

A further objective of certain embodiments of the present invention is to provide a femtocell. A network system comprises the femtocell, a base station, and a femto gateway. The femtocell is connected to the femto gateway via the base station. The femtocell comprises a broadband transceiver, an RF transceiver, and a processing unit. The broadband transceiver is configured to receive a turn-on signal transmitted by the femto gateway via the base station. The processing unit is configured to turn on the RF transceiver after the broadband transceiver receives the turn-on signal. The broadband transceiver is further configured to transmit an ACK signal to the femto gateway after the processing unit turns on the RF transceiver.

Yet another objective of certain embodiments of the present invention is to provide a communication method for a base station. A network system comprises a femtocell, the base station, and a femto gateway. The femtocell is connected to the femto gateway via the base station. The communication method comprises the following steps of: (a) enabling the base station to determine that a mobile station enters signal coverage of the base station; (b) enabling the base station to transmit a notification signal to the femto gateway after the step (a) so that the femto gateway transmits a turn-on signal; (c) enabling the base station to relay the turn-on signal to the femtocell after the step (b) so that the femtocell turns on a RF transceiver of the femtocell and transmits an ACK signal after receiving the turn-on signal; and (d) enabling the base station to relay the ACK signal to the femto gateway after the step (c).

Yet a further objective of certain embodiments of the present invention is to provide a communication method for a femto gateway. A network system comprises a femtocell, a base station, and the femto gateway. The femtocell is connected to the femto gateway via the base station. The communication method comprises the following steps of: (a) enabling the femto gateway to receive a notification signal from the base station; (b) enabling the femto gateway to, choose the femtocell after the step (a); (c) enabling the femto gateway to transmit a turn-on signal to the femtocell after the step (b) so that the femtocell turns on an RF transceiver of the femtocell and transmits an ACK signal after receiving the turn-on signal; and (d) enabling the femto gateway to receive via the base station the ACK signal transmitted by the femtocell after the step (c).

Still another objective of certain embodiments of the present invention is to provide a communication method for a femtocell. A network system comprises the femtocell, a base station, and a femto gateway. The femtocell is connected to the femto gateway via the base station. The communication method comprises the following steps of: (a) enabling the femtocell to receive a turn-on signal transmitted by the femto gateway via the base station; (b) enabling the femtocell to turn on an RF transceiver of the femtocell after the step (a); and (c) enabling the femtocell to transmit an ACK signal to the femto gateway after the step (b).

According to particular embodiments, the femtocell turns off its RF transceiver when the femtocell remains idle for a predetermined time interval. Once a mobile device approaches to the femtocell, the base station adjacent to the femtocell will notify the femto gateway so that the femto gateway can notify the femtocell to turn on the RF transceiver. Accordingly, the femtocell of the present invention consumes less power and will not interfere adjacent femtocells when the femtocell is idle.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 shows a conventional network system adopting a femtocell structure;

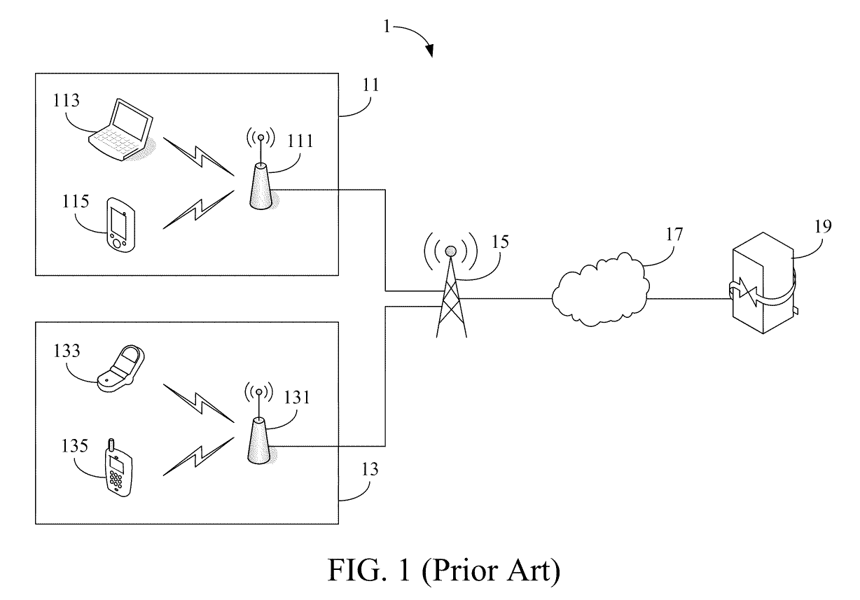

FIG. 2A is a schematic view of a first embodiment of the present invention;

FIG. 2B is a schematic view of a femtocell, a base station and a femtocell gateway of the first embodiment;

FIG. 2C is a schematic view depicting signal transmission of a network system conforming to the LTE standard; and

FIG. 3 is a flowchart of a second embodiment of the present invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the spirit and scope of the invention as defined by the appended claims.

### DETAILED DESCRIPTION

Description of the following embodiments is only for purpose to illustrate rather than to limit the present invention. It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

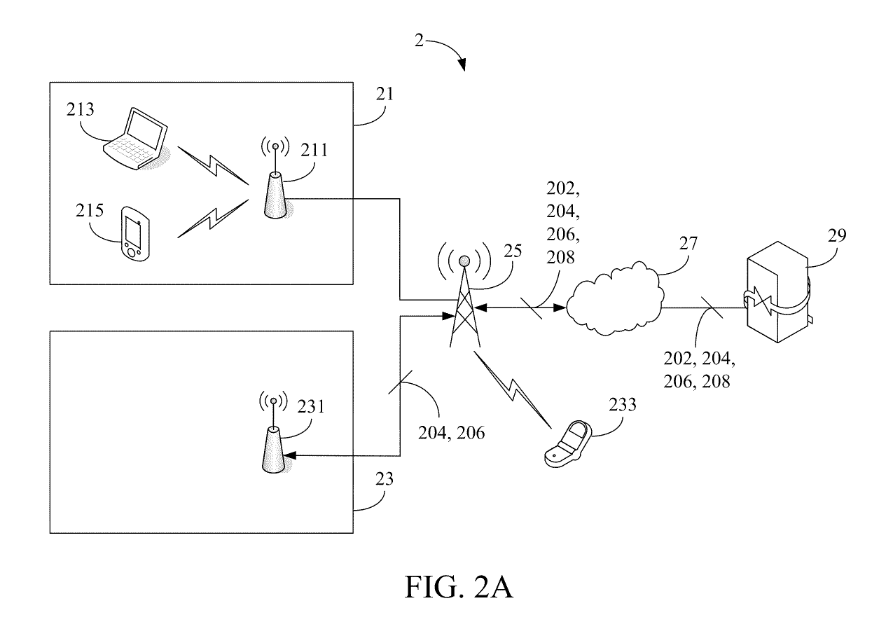

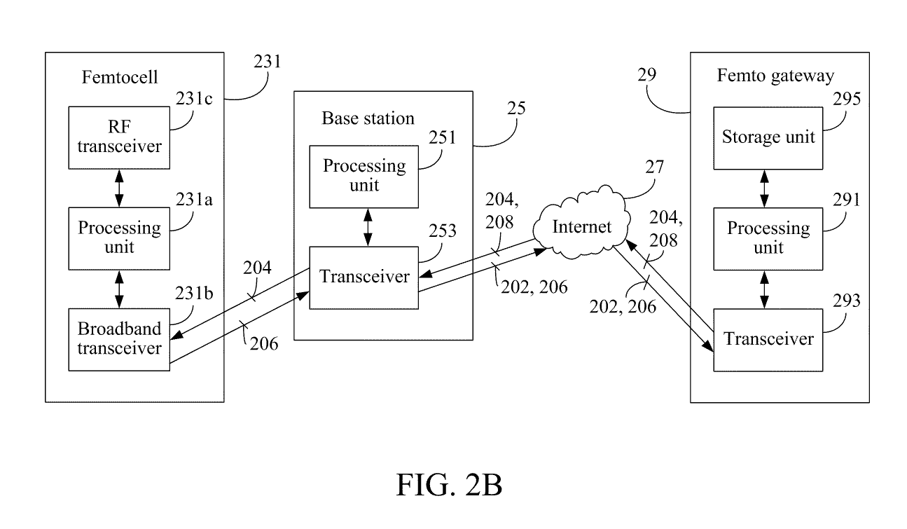

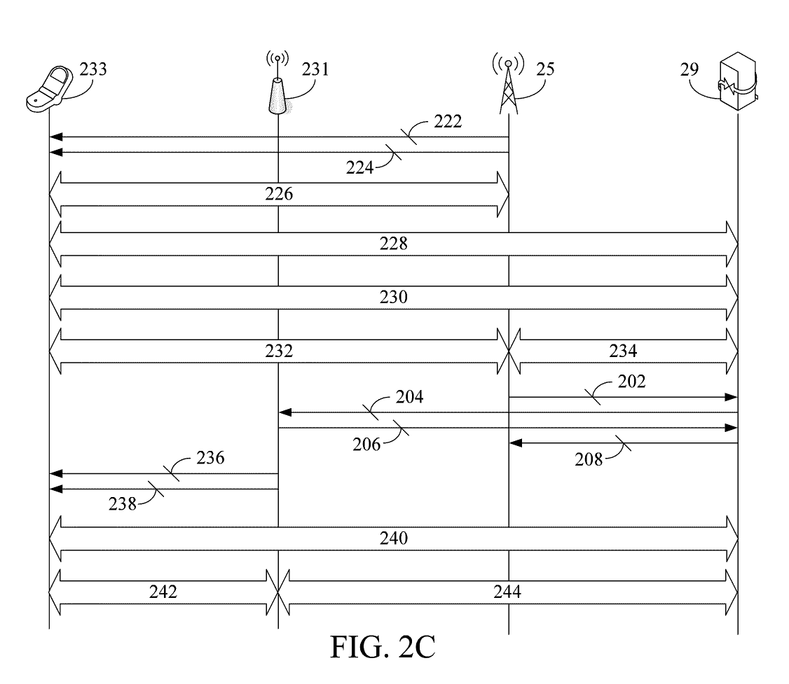

A first embodiment of the present invention is a network system 2, a structural view of which is shown in FIG. 2A. A base station 25 of the network system 2 is connected to a femto gateway 29 via the Internet 27. Femtocells 211, 231 are deployed in houses 21, 23 respectively and connected (e.g., via a home network connection) to the base station 25 respectively. In other words, each of the femtocells 211, 231 is individually connected to the femto gateway 29 via the base station 25. Two mobile stations 213, 215 are located within the house 21 and connected to the network via the femtocell 211 respectively; and currently no mobile station exists in the house 23.

Referring to FIG. 2B together, a schematic view of the femtocell 231, a base station 25, and the femto gateway 29 is shown therein. The femtocell 231 comprises a processing unit 231a, a broadband transceiver 231b, and an RF transceiver 231c. The base station 25 comprises a processing unit 251 and a transceiver 253. The femto gateway 29 comprises a processing unit 291, a transceiver 293, and a storage unit 295.

As currently no mobile station exists in the house 23, the processing unit 231a of the femtocell 231 determines that the RF transceiver 231c remains idle for a predetermined time interval so the processing unit 231a turns off the RF transceiver 231b. Herein below, with reference to a case in which another mobile station 233 enters the signal coverage of the base station 25, operations of the femtocell 231, the base station 25 and the femto gateway 29 of the first embodiment will be described.

When the mobile station 233 enters the signal coverage of the base station 25, the processing unit 251 of the base station 25 determines that the mobile station 233 has entered the signal coverage of the base station 25. Then, the transceiver 253 of the base station 25 transmits a notification signal 202 to the femto gateway 29. After the transceiver 293 of the femto gateway 29 receives the notification signal 202, the femto gateway 29 learns that the mobile station 233 has entered the signal coverage of the base station 25.

In this embodiment, the storage unit 295 of the femto gateway 29 stores a correspondence relationship table which indicates that the mobile station 233 corresponds to the femtocell 231, i.e., the mobile station 233 will be served by the femtocell 231. Hence, after the notification signal 202 is received by the transceiver 293, the processing unit 291 of the femto gateway 29 chooses the femtocell 231 according to the correspondence relationship table. Subsequently, the transceiver 293 of the femto gateway 29 transmits a turn-on signal 204 to the femtocell 231 to notify the femtocell 231 to turn on the RF transceiver 231c thereof. The turn-on signal transmitted by the femto gateway 29 is firstly transmitted through the base station 25 and then relayed by the transceiver 253 of the base station 25 to the femtocell 231. Finally, the turn-on signal 204 is received by the broadband transceiver 231b of the femtocell 231.

Once the turn-on signal 204 is received by the broadband transceiver 231b of the femtocell 231, the processing unit 231a turns on the RF transceiver 231c. Afterwards, the broadband transceiver 231b of the femtocell 231 transmits an ACK signal 206 to the femto gateway 29 to inform the femto gateway 29 that the femtocell 231 has turned on the RF transceiver 231c according to the turn-on signal 204. The ACK signal 206 transmitted by the femtocell 231 is firstly transmitted through the base station 25 and then relayed by the transceiver 253 of the base station 25 to the femto gateway 29. Finally, the ACK signal 206 is received by the transceiver 293 of the femto gateway 29.

Through the aforesaid descriptions, once the mobile station 233 enters the signal coverage of the base station 25, the base station 25 and the femto gateway 29 will notify the femtocell 231 to turn on the RF transceiver 231c thereof. Thus, the RF transceiver 231c of the femtocell 231 can provide services to the mobile station 233.

In the first embodiment, the following operations may further be executed to make operation of the network system 2 more efficient. After receiving the ACK signal 206, the transceiver 293 of the femto gateway 29 may transmit a turn-on completion signal 208 to the base station 25. After the turn-on completion signal 208 is received by the transceiver 253 of the base station 25, the base station 25 learns that the femtocell 231 has turned on the RF transceiver 231C thereof. Thereafter, the base station 25 can determine whether to perform a handover procedure. If the base station 25 determines to perform a handover procedure, then connection between the base station 25 and the mobile station 233 will be disconnected after the connection between the mobile station 233 and the RF transceiver 231c of the femtocell 231 has been established.

It shall be appreciated that, in the first embodiment, after the notification signal 202 is received by the transceiver 293, the femtocell 231 will be chosen by the processing unit 291 of the femto gateway 29 according to the correspondence relationship table stored in the storage unit 295. In other embodiments, the femto gateway 29 may omit storing the correspondence relationship table, in which case the processing unit 291 of the femto gateway 29 will choose all femtocells 211, 231 connected to the base station 25. In other words, the RF transceivers of both the femtocells 211, 231 will be turned on when the femto gateway 29 omits storing the correspondence relationship table.

What described in the first embodiment is a scenario, in which the mobile station 233 gradually approaches to the house 23, i.e., the mobile station 233 enters the signal coverage of the base station 25. In fact, arrangement of the first embodiment is also applicable to other scenarios. For example, it may be a scenario that a mobile station already exists in the house 23 but the mobile station is powered off. In this scenario, once the mobile station is powered on, the mobile station will establish a connection with the base station 25 at first. As the mobile station 233 is located within the signal coverage of the base station 25, the wireless system 2 will also implement the aforesaid operations to turn on the RF transceiver 231C so that the mobile station 233 can establish the connection via the RF transceiver 231C.

Furthermore, the network system 2 of the first embodiment is not limited to any particular network system. For example, the network system 2 may conform to the Worldwide Interoperability for microwave access (WiMAX) standard, the Long Term Evolution (LTE) standard, or the Third Generation (3G) standard.

Referring next to FIG. 2C, a schematic view illustrating signal transmission of the network system 2 when conforming to the LTE standard is shown therein.

After the mobile station 233 enters the signal coverage of the base station 25, the base station 25 performs an initialization process with the mobile station 233 to establish a connection therebetween. In more details, the base station 25 transmits a synchronization signal 222 to the mobile station 233; in the LTE standard, the synchronization signal 222 is a primary synchronization signal (PSS)/secondary synchronization signal (SSS). Next, the base station 25 transmits a basic information signal 224 to the mobile station 233; in the LTE standard, the basic information signal 224 comprises a master information block (MIB), a system information block (SIB), and system information (SI). Then, a setting procedure 226 is performed between the base station 25 and the mobile station 233; in the LTE standard, the setting procedure 226 is a radio resource control (RRC) connection setting procedure. Afterwards, a safety authentication procedure 228 and an evolved packet system (ESP) loading service setting procedure 230 is performed between the mobile station 233 and the femto gateway 29. Afterwards, a service data transmission procedure 232 may be performed between the mobile station 233 and the base station 25, and a service data transmission procedure 234 may also be performed between the base station 25 and the femto gateway 29. This is well-known to those familiar with the LTE standard, so the details will not be further described herein.

In this case, as the mobile station 233 is located within the signal coverage of the base station 25, the base station 25 determines that the mobile station 233 approaches to the femtocell 231. Accordingly, the base station 25 transmits a notification signal 202 to the femto gateway 29. The femto gateway 29 then transmits a turn-on signal 204, which is relayed by the base station 25, to the femtocell 231. After receiving the turn-on signal 204, the femtocell 231 turns on the RF transceiver 231c thereof and transmits an ACK signal 206. The ACK signal 206 is relayed by the base station 25 to the femto gateway 29. Then, a turn-on completion signal 208 is transmitted by the femto gateway 29 to the base station 25.

After receiving the turn-on signal 204, the femtocell 231 transmits a synchronization signal 236 to the mobile station 233. Similarly, in the LTE standard, the synchronization signal 236 is a PSS/SSS. Next, the femtocell 231 transmits a basic information signal 238 to the mobile station 233; in the LTE standard, the basic information signal 238 comprises an MIB, an SIB, and an SI. Through the synchronization signal 236 and the basic information signal 238, the femtocell 231 establishes a connection with the mobile station 233.

As the femtocell 231 has established a connection with the mobile station 233 and the base station 25 has received the turn-on completion signal 208 (and thus learned that the femtocell 231 has turned on the RF transceiver 231c thereof), a handover procedure 240 may now be performed between the base station 25 and the mobile station 233. The handover procedure 240 may be initiated by the mobile station 233 or the base station 25. Upon completion of the handover procedure, a service data transmission procedure 242 may be performed between the mobile station 233 and the femtocell 231, and a service data transmission procedure 244 may also be performed between the femtocell 231 and the femto gateway 29.

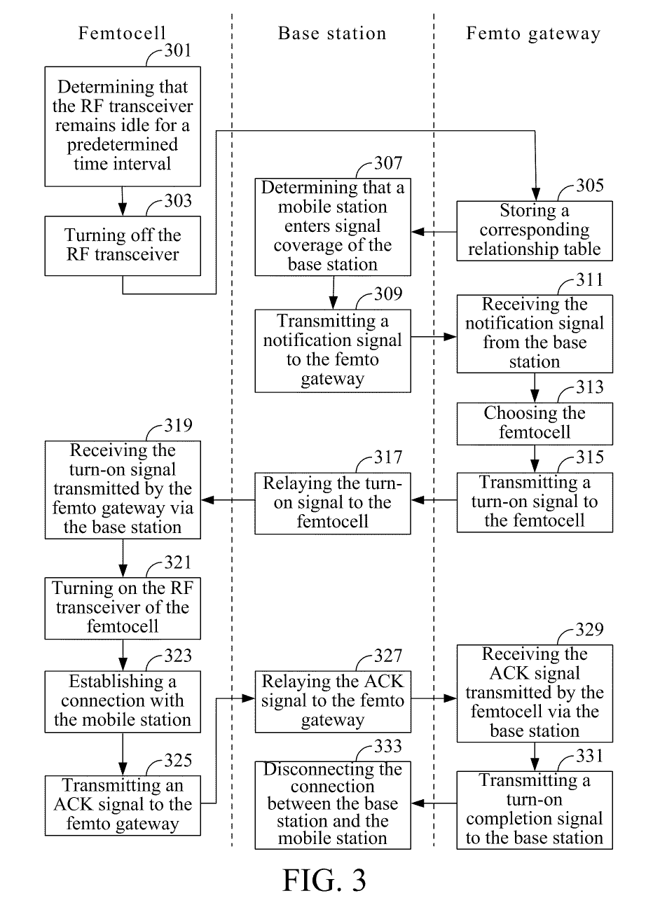

A second embodiment of the present invention is a communication method, a flowchart of which is depicted in FIG. 3. The communication method is adapted for use in a network system. The network system comprises a femtocell, a base station, and a femto gateway, e.g., the femtocell 231, the base station 25, and the femto gateway 29 described in the first embodiment.

Firstly, step 301 is executed to enable the femtocell to determine that an RF transceiver of the femtocell remains idle for a predetermined time interval. Next, step 303 is executed to enable the femtocell to turn off the RF transceiver. On the other hand, step 305 is executed to enable the femto gateway to store a correspondence relationship table. The correspondence relationship table indicates correspondence relationships between mobile stations and femtocells. It shall be appreciated that, in this embodiment, step 305 is executed subsequent to step 303; however, in other examples, step 305 may also be executed prior to step 303 or even prior to step 301.

Thereafter, step 307 is executed to enable the base station to determine that a mobile station enters signal coverage of the base station, and step 309 is executed to enable the base station to transmit a notification signal to the femto gateway. Then, step 311 is executed to enable the femto gateway to receive the notification signal from the base station. In response to the notification signal, step 313 is firstly executed to enable the femto gateway to choose the femtocell corresponding to the mobile station according to the correspondence relationship table, and step 315 is executed to enable the femto gateway to transmit a turn-on signal to the femtocell.

When the turn-on signal is being transmitted through the base station, step 317 is executed to enable the base station to relay the turn-on signal to the femtocell. Then, step 319 is executed to enable the femtocell to receive the turn-on signal. After the turn-on signal is received, step 321 is executed to enable the femtocell to turn on the RF transceiver of the femtocell, and step 323 is executed to enable the femtocell to establish a connection with the mobile station. Afterwards, step 325 is executed to enable the femtocell to transmit an ACK signal to the femto gateway.

When the ACK signal is being transmitted through the base station, step 327 is executed to enable the base station to relay the ACK signal to the femto gateway, and step 329 is executed to enable the femto gateway to receive the ACK signal. After the ACK signal is received, step 331 is executed to enable the femto gateway to transmit a turn-on completion signal to the base station. Afterwards, step 333 is executed to enable the base station to be disconnected from the mobile station.

Likewise, the communication method of the second embodiment is not limited to any particular network system. For example, the network system adopting this communication method may conform to the WiMAX standard, the LTE standard, or the 3G standard.

In addition to the aforesaid steps, the communication method of the present invention can also execute all the operations and functions set forth in the first embodiment. How the communication method of the present invention executes these operations and functions will be readily appreciated by those of ordinary skill in the art based on the explanation of the first embodiment, and thus will not be further described herein.

According to the above description, the femtocell turns off its RF transceiver when the femtocell remains idle for a predetermined time interval. Once a mobile device approaches to the femtocell, the base station adjacent to the femtocell will notify the femto gateway so that the femto gateway will notify the femtocell to turn on the RF transceiver. By having this arrangement, the femtocell consumes less power and will not interfere with signal transmissions of adjacent femtocells when the femtocell is idle.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A base station, a network system comprising a femtocell, the base station, and a femto gateway, the femtocell being connected to the femto gateway via the base station, the base station comprising:
a processing unit, being configured to determine that a mobile station enters a signal coverage of the base station; and
a transceiver, being configured to transmit a notification signal to the femto gateway after the processing unit determines that the mobile station enters the signal coverage of the base station so that the femto gateway transmits a turn-on signal in response to the notification signal, the transceiver being further configured to relay the turn-on signal to the femtocell so that the femtocell turns on a radio frequency (RF) transceiver of the femtocell and transmits an acknowledgement (ACK) signal after receiving the turn-on signal, and the transceiver being further configured to relay the ACK signal to the femto gateway.

2. The base station as claimed in claim 1, wherein the transceiver is further configured to receive a turn-on completion signal from the femto gateway, and the turn-on completion signal represents that the femtocell has been turned on.

3. The base station as claimed in claim 1, wherein the processing unit is further configured to disconnect the connection between base station and the mobile station after receiving the turn-on completion signal.

4. A femto gateway, a network system comprising a femtocell, a base station, and the femto gateway, and the femtocell being connected to the femto gateway via the base station, the femto gateway comprising:
a transceiver, being configured to receive a notification signal from the base station; and
a processing unit, being configured to choose the femtocell after the transceiver receives the notification signal;
wherein the transceiver is further configured to transmit a turn-on signal to the femtocell after the processing unit chooses the femtocell so that the femtocell turns on an RF transceiver of the femtocell and transmits an ACK signal after receiving the turn-on signal, and the transceiver is further configured to receive the ACK signal transmitted by the femtocell via the base station.

5. The femto gateway as claimed in claim 4, wherein the transceiver is further configured to transmit a turn-on completion signal to the base station so that the base station disconnect the connection between the base station and the mobile station according to the turn-on completion signal.

6. The femto gateway as claimed in claim 5, further comprising:
a storage unit, being configured to store a correspondence relationship table, wherein the correspondence relationship table indicates that the mobile station corresponds to the femtocell;
wherein the processing unit chooses the femtocell according to the correspondence relationship table.

7. A femtocell, a network system comprising the femtocell, a base station and a femto gateway, and the femtocell being connected to the femto gateway via the base station, the femtocell comprising:
a broadband transceiver, being configured to receive a turn-on signal transmitted by the femto gateway via the base station;
an RF transceiver; and
a processing unit, being configured to turn on the RF transceiver after the broadband transceiver receives the turn-on signal;
wherein the broadband transceiver is further configured to transmit an ACK signal to the femto gateway after the processing unit turns on the RF transceiver.

8. The femtocell as claimed in claim 7, wherein the RF transceiver is further configured to establish a connection with a mobile station after being turned on.

9. The femtocell as claimed in claim 7, wherein the processing unit is further configured to determine that the RF transceiver remains idle for a predetermined time interval and is further configured to turn off the RF receiver after the processing unit determines that the RF transceiver remains idle for the predetermined time interval.

10. A communication method for a base station, a network system comprising a femtocell, the base station, and a femto gateway, and the femtocell being connected to the femto gateway via the base station, the communication method comprising the following steps of:
(a) enabling the base station to determine that a mobile station enters a signal coverage of the base station;
(b) enabling the base station to transmit a notification signal to the femto gateway after the step (a) so that the femto gateway transmits a turn-on signal after receiving the notification signal;
(c) enabling the base station to relay the turn-on signal to the femtocell after the step (b) so that the femtocell turns on an RF transceiver of the femtocell and transmits an ACK signal after receiving the turn-on signal; and
(d) enabling the base station to relay the ACK signal to the femto gateway after the step (c).

11. The communication method as claimed in claim 10, further comprising the following step of:
(e) enabling the base station to receive a turn-on completion signal from the femto gateway after the step (d), wherein the turn-on completion signal represents that the femtocell has been turned on.

12. The communication method as claimed in claim 11, further comprising the following step of:
(f) enabling the base station to disconnect the connection between the base station and the mobile station after receiving the turn-on completion signal.

13. A communication method for a femto gateway, a network system comprising a femtocell, a base station, and the femto gateway, and the femtocell being connected to the femto gateway via the base station, the communication method comprising the following steps of:
(a) enabling the femto gateway to receive a notification signal from the base station;
(b) enabling the femto gateway to choose the femtocell after the step (a);
(c) enabling the femto gateway to transmit a turn-on signal to the femtocell after the step (b) so that the femtocell turns on an RF transceiver of the femtocell and transmits an ACK signal after receiving the turn-on signal; and
(d) enabling the femto gateway to receive via the base station the ACK signal transmitted by the femtocell after the step (c).

14. The communication method as claimed in claim 13, further comprising the following step of:
(e) enabling the femto gateway to transmit a turn-on completion signal to the base station after the step (d), wherein the turn-on completion signal represents that the femtocell has been turned on.

15. The communication method as claimed in claim 14, further comprising the following step of:
enabling the femto gateway to store a correspondence relationship table prior to the step (b), wherein the correspondence relationship table indicates that the mobile station corresponds to the femtocell;
wherein the femtocell is chosen according to the correspondence relationship table in the step (b).

16. A communication method for a femtocell, a network system comprising the femtocell, a base station, and a femto gateway, and the femtocell being connected to the femto gateway via the base station, the communication method comprising the following steps of:
(a) enabling the femtocell to receive a turn-on signal transmitted by the femto gateway via the base station;
(b) enabling the femtocell to turn on an RF transceiver of the femtocell after the step (a); and
(c) enabling the femtocell to transmit an ACK signal to the femto gateway after the step (b).

17. The communication method as claimed in claim 16, further comprising the step of:
enabling the femtocell to establish a connection with a mobile station after the step (b).

18. The communication method as claimed in claim 16, further comprising the step of:
(d) enabling the femtocell to determine that the RF transceiver remains idle for a predetermined time interval; and
(e) enabling the femtocell to turn off the RF transceiver after the step (d).
